(19) United States
(12) Patent Application Publication
(10) Pub. No.: US 2014/0347334 A1
(43) Pub. Date: Nov. 27, 2014

(54) DISPLAY DEVICE, PRODUCTION METHOD FOR DISPLAY DEVICE, AND PRODUCTION DEVICE FOR DISPLAY DEVICE

(71) Applicants: Yuhsuke Nii, Osaka (JP); Masayoshi Okita, Osaka (JP)

(72) Inventors: Yuhsuke Nii, Osaka (JP); Masayoshi Okita, Osaka (JP)

(73) Assignee: SHARP KABUSHIKI KAISHA, Osaka (JP)

(21) Appl. No.: 14/344,149

(22) PCT Filed: Sep. 10, 2012
(86) PCT No.: PCT/JP2012/005724

§ 371 Date: Mar. 11, 2014

(30) Foreign Application Priority Data
Sep. 15, 2011 (JP) 2011-202387

(51) Int. Cl. G09G 5/00; G09G 5/02

(52) U.S. Cl. CPC G09G 5/008; G09G 5/02; G09G 2340/06; G09G 2300/0452
USPC 345/204; 345/55

(57) ABSTRACT

In order to enable suitable timing control of a display operation while simplifying a circuit configuration, a display device includes: an oscillation circuit 207 that oscillates a clock signal; a non-volatile memory 206 that stores values setting forth display operation timing of the display device in accordance with the clock signal; and a timing signal output circuit 209 that outputs timing signals controlling the display operation timing on the basis of pulse counts of the clock signal and the values stored in the non-volatile memory 206. The values stored in the non-volatile memory 206 correspond to deviations in oscillation frequency of the oscillation circuit 207 and deviations in delay of display operation from respective targets.

### TECHNICAL FIELD

The present invention relates to a display device that displays an image on the basis of an image signal, a method of manufacturing this display device, and a manufacturing device of this display device. In particular, the present invention relates to a display device and the like in which display operation timing is controlled on the basis of a clock signal oscillated inside the display device.

### BACKGROUND ART

Among display devices that use a liquid crystal display panel or the like, there is a configuration in which a clock signal is oscillated inside the display device in order to control display operation timing, the clock signal then being used to generate a timing signal. This makes it unnecessary to transmit high frequency clock signals and can reduce the number of signal lines and input terminals.

In this type of display device, a configuration is known in which a PLL (phase locked loop) circuit and feedback control are used to generate a clock signal in order to enhance the accuracy of timing control with respect to variation and the like in the circuit operation (Patent Documents 1 and 2, for example).

### RELATED ART DOCUMENTS

### Patent Documents

Patent Document 1: Japanese Patent Application Laid-Open Publication No. 2005-148557

Patent Document 2: Japanese Patent Application Laid-Open Publication No. 2008-15006

### SUMMARY OF THE INVENTION

### Problems to be Solved by the Invention

However, PLL circuits and feedback control circuits require a relatively large circuit size, and this tends to make the driving part and the display device itself larger and cause an increase in manufacturing costs.

The present invention was made in view of these problems, and aims at enabling suitable timing control of display operation while simplifying the circuit configuration.

A first aspect of the present invention is a display device, including:

an oscillation circuit that oscillates a clock signal;

a non-volatile memory that stores values setting forth display operation timing of the display device; and

a timing signal output circuit that outputs timing signals controlling the display operation timing on the basis of pulse counts of the clock signal and the values stored in the non-volatile memory,

wherein the values stored in the non-volatile memory correspond to deviations in oscillation frequency of the oscillation circuit and deviations in delay of operation timing.

In the first aspect of the present invention,

values corresponding to deviation in oscillation frequency of the oscillation circuit and deviation in delay of the display operation are stored in the non-volatile memory, and timing signals that control display operation timing are outputted from the timing signal output circuit on the basis of these stored values in the non-volatile memory and the pulse count of the clock signal. Accordingly, display operation with suitable timing can be performed with ease due to compensation for the deviations and the like in oscillation frequency of the oscillation circuit. Furthermore, relatively large circuit sizes such as for PLL circuits or feedback control circuits are not necessary, and thus, a decrease in size and manufacturing cost of the driving part and display device can also be achieved and the like with ease.

A second aspect of the present invention is the first aspect of the present invention,

wherein display is performed in accordance with a charge that is stored between a pixel electrode and an opposite common electrode, and

wherein the timing signal controls a storage time of the charge between the pixel electrode and the opposite common electrode.

In the second aspect of the present invention,

the storage time of the charge to between the pixel electrode and the opposite common electrode can be suitably controlled, and display quality can be improved and the like with ease.

A third aspect of the present invention is the second aspect of the present invention,

wherein an image signal voltage is sequentially applied to respective pixel electrodes of red pixels of one display line, green pixels of one display line, or blue pixels of one display line, and

wherein the timing signal controls switching timing of the image signal voltage.

In the third aspect of the present invention,

operation timing for the display of the respective colors is suitably controlled, and the display luminance, color balance, and the like can be improved and the like with ease.

A fourth aspect of the present invention is a method of manufacturing a display device that has: an oscillation circuit that oscillates a clock signal; a non-volatile memory that stores values setting forth display operation timing of the display device; and a timing signal output circuit that outputs timing signals controlling the display operation timing on the basis of pulse counts of the clock signal and the values stored in the non-volatile memory, the method comprising:

measuring actual operation timing of the display device reflecting deviation in oscillation frequency of the oscillation circuit and deviation in delay of display operation;

calculating, on the basis of the measured operation timing, the values to be stored in the non-volatile memory at which the operation timing will be within a permissible range, and

storing the calculated values in the non-volatile memory.

A fifth aspect of the present invention is the fourth aspect of the present invention,

wherein the display device is configured such that display is performed in accordance with a charge that is stored between a pixel electrode and an opposite common electrode, and

wherein the timing signal controls a storage time of the charge between the pixel electrode and the opposite common electrode.

A sixth aspect of the present invention is the fifth aspect of the present invention,

wherein the display device is configured such that an image signal voltage is sequentially applied to respective pixel electrodes of red pixels of one display line, green pixels of one display line, or blue pixels of one display line, and

wherein the timing signal controls switching timing of the image signal voltage.

In the fourth to sixth aspects of the present invention,

display operation with a suitable timing is performed as described in the first to third aspects of the present invention, and a display device that can improve display quality can be manufactured with ease.

A seventh aspect of the present invention is the fourth aspect of the present invention,

wherein, in the step of measuring, operation delay time of a circuit that controls operation timing is measured by a frequency of the clock signal and the timing signal.

In the seventh aspect of the present invention,

values corresponding to deviations in oscillation frequency of the oscillation circuit and deviations in the delay of display operation can be found with ease.

An eight aspect of the present invention is a manufacturing device of a display device that has: an oscillation circuit that oscillates a clock signal; a non-volatile memory that stores values setting forth display operation timing of the display device; and a timing signal output circuit that outputs timing signals controlling the display operation timing on the basis of pulse counts of the clock signal and the values stored in the non-volatile memory, the manufacturing device comprising:

a measuring part that measures actual operation timing of the display device reflecting deviation in oscillation frequency of the oscillation circuit and deviation in delay of display operation;

a calculating part that calculates, on the basis of the measured operation timing, the values to be stored in the non-volatile memory at which the operation timing will be within a permissible range,

a setting part that stores the calculated values in the non-volatile memory.

A ninth aspect of the present invention is the eighth aspect of the present invention,

wherein the display device is configured such that display is performed in accordance with a charge that is stored between a pixel electrode and an opposite common electrode, and

wherein the timing signal controls a storage time of the charge between the pixel electrode and the opposite common electrode.

A tenth aspect of the present invention is the ninth aspect of the present invention,

wherein the display device is configured such that an image signal voltage is sequentially applied to respective pixel electrodes of red pixels of one display line, green pixels of one display line, or blue pixels of one display line, and

wherein the timing signal controls switching timing of the image signal voltage.

In the eighth to tenth aspects of the present invention,

display operation with a suitable timing is performed as described in the first to third aspects of the present invention, and a display device that can improve display quality can be manufactured with ease.

An eleventh aspect of the present invention is the eight aspect of the present invention,

wherein the measuring part operation delay time of a circuit that controls the operation timing is measured by a frequency of the clock signal and the timing signal.

In the eleventh aspect of the present invention,

values corresponding to deviations in oscillation frequency of the oscillation circuit and deviations in the delay of display operation can be found with ease as described in the seventh aspect of the present invention.

### Effects of the Invention

According to the present invention, it is possible to enable suitable timing control of display operation while simplifying the circuit configuration.

### BRIEF DESCRIPTION OF THE DRAWINGS

FIG. 1 is a block diagram showing a configuration of primary parts of a liquid crystal display device 101.

FIG. 2 is a block diagram showing a configuration of primary parts of a liquid crystal driver 103.

FIG. 3 is a timing chart showing primary timing signals.

FIG. 4 is a chart showing examples of timing setting data.

FIG. 5 is a block diagram showing a configuration of an inspection device 301.

FIG. 6 is a flow chart showing operation of the inspection device 301.

### DETAILED DESCRIPTION OF EMBODIMENTS

An embodiment of the present invention will be described in detail below with reference to drawings.

(Schematic Configuration of Liquid Crystal Display Device 101)

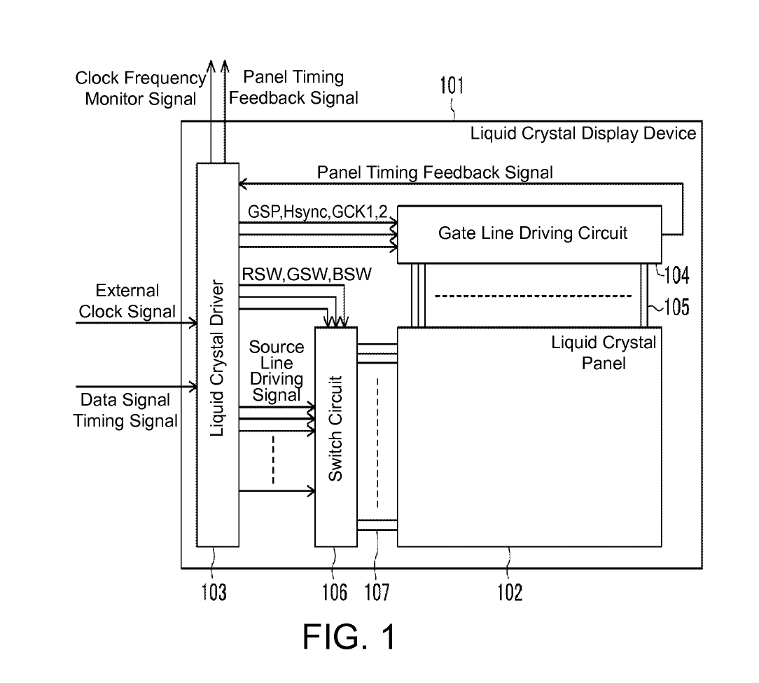

An active matrix liquid crystal display device will be explained as an example of a display device of the present invention. As shown in FIG. 1, the liquid crystal display device 101 includes a liquid crystal panel 102, a liquid crystal driver 103, a gate line driving circuit 104, and a switch circuit 106.

As described later, the liquid crystal driver 103 outputs various types of timing signals that control operation of respective parts of the liquid crystal display device 101 and also outputs source line driving signals on the basis of data signals such as image data.

The gate line driving circuit 104 has shift registers with stages that are equal in number to the number of display lines, for example, and selectively activates gate signals that will be outputted to a plurality of gate lines 105 on the basis of a gate start pulse GSP, horizontal synchronizing signal Hsync, and two-phase gate clock signals GCK 1 and GCK 2 outputted from the liquid crystal driver 103. The gate line driving circuit 104 outputs a panel timing feedback signal (specifically, a pulse signal outputted from the final stage of the shift register, for example) in accordance with the delay of the shift register to the liquid crystal driver 103.

As described later, the switch circuit 106 switches the source line driving signals inputted from the liquid crystal driver 103 to respective source lines 107 of respective display colors on the basis of R, G, B switch signals RSW, GSW, and BSW, which are timing signals, and the switch circuit 106 then outputs these.

(Detailed Configuration of Liquid Crystal Driver 103)

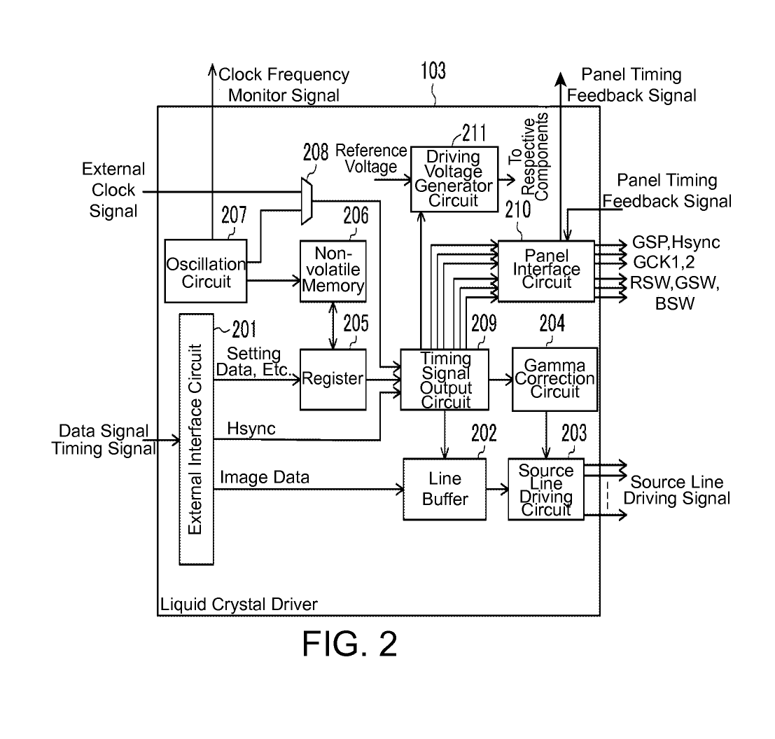

As shown in FIG. 2, for example, the liquid crystal driver 103 includes an external interface circuit 201, a line buffer 202, a source line driving circuit 203, a gamma correction circuit 204, a register 205, a non-volatile memory 206, an oscillation circuit 207, a selector 208, a timing signal output circuit 209, a panel interface circuit 210, and a driving voltage generator circuit 211.

The external interface circuit 201 provides various types of data signals (such as image data and setting data, for example) and timing signals (the horizontal synchronizing signals Hsync, for example) inputted from outside the liquid crystal display device 101 to the respective parts in the liquid crystal driver 103.

The line buffer 202 outputs image data from the external interface circuit 201 at a timing corresponding to the control of the timing signal output circuit 209.

The source line driving circuit 203 outputs a source line driving signal at a voltage corresponding to the image data outputted from the line buffer 202.

The gamma correction circuit 204 outputs a prescribed voltage for gamma correction to the source line driving signal outputted from the source line driving circuit 203.

The register 205 sends timing setting data and the like received from the external interface circuit 201 to the respective parts in the liquid crystal driver 103 and relays data transmissions between the respective parts.

The non-volatile memory 206 stores setting data inputted through the register 205 and also outputs this setting data to the timing signal output circuit 209 through the register 205. The specific configuration of the non-volatile memory 206 has no specific limitations, and various configurations such as a charge storage-type, fuse cutting type, anti-fuse, and the like can be applied.

The oscillation circuit 207 oscillates a clock signal that acts as a reference for the operating timing of the respective parts in the liquid crystal display device 101 and supplies this clock signal to the respective parts.

The selector 208 switches between the clock signal oscillated by the oscillation circuit 207 and the external clock signal inputted from outside of the liquid crystal display device 101 and can supply these to the timing signal output circuit 209 and the like as necessary. A configuration that is capable of supplying such an external clock signal does not necessarily need to be provided.

The timing signal output circuit 209 generates timing signals to control operation timing of the respective parts in the liquid crystal display device 101 on the basis of the horizontal synchronizing signal Hsync received from outside the liquid crystal display device 101, the clock signal inputted from the oscillation circuit 207 through the selector 208, and the setting data inputted from the non-volatile memory 206 through the register 205. The detailed operation of this timing signal output circuit 209 is described later.

In accordance with the timing signals generated by the timing signal output circuit 209, the panel interface circuit 210 outputs the gate start pulse GSP, horizontal synchronizing signal Hsync, gate clock signals GCK 1 and GCK 2, and the switch signals RSW, GSW, BSW that control the switching of the switch circuit 106.

The driving voltage generator circuit 211 supplies a prescribed driving voltage to the respective parts in the liquid crystal display device 101.

(Schematic Operation of Liquid Crystal Display Device 101)

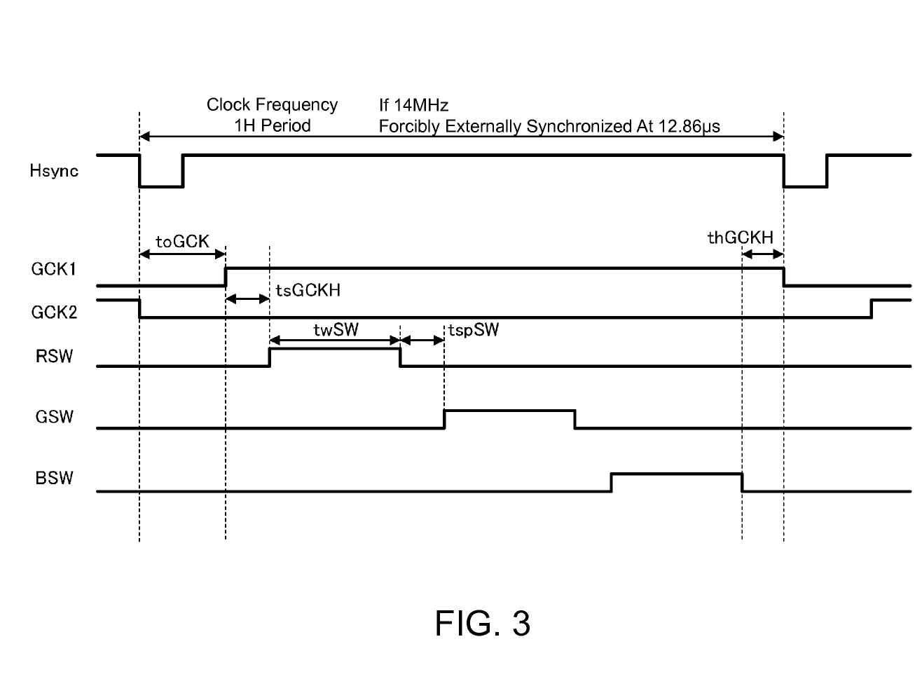

As shown in FIG. 3, for example, from the timing signal output circuit 209 of the liquid crystal driver 103, the gate start pulse GSP is outputted every 1 vertical (1V) period, the horizontal synchronizing signal Hsync that enters L (low) level every 1 horizontal (1H) period is outputted, and the two-phase gate clock signals GCK1 and GCK2 that alternately enter H (high) level every 1H period are also outputted through the panel interface circuit 210. On the basis of this, the gate line driving circuit 104 selectively and sequentially sets the gate signals outputted to the gate line 105 to H level while the gate clock signal GCK 1 or GCK 2 is at H level. This turns ON the not-shown TFTs (thin-film transistors) of the liquid crystal panel 102 on the respective scan lines.

The switch signals RSW, GSW, and BSW inputted from the timing signal output circuit 209 to the switch circuit 106 through the panel interface circuit 210 are selectively and sequentially set to H level in the period when the gate clock signal GCK1 or GCK2 is at H level. Meanwhile, a source voltage corresponding to image data relating to red, blue, and green pixels is inputted to the switch circuit 106 from the source line driving circuit 203 of the liquid crystal driver 103. In the switch circuit 106, the source voltages outputted from the source line driving circuit 203 are applied to the source lines 107 of the respective color pixels in accordance with the respective switch signals RSW, GSW, and BSW each entering H level.

Display is performed through the operation described above by the source voltages inputted from the respective source lines 107 being applied to the pixel electrodes of the respective scan lines and the charge corresponding to the image data being stored.

(Operation Timing of Liquid Crystal Display Device 101)

The gate clock signals GCK 1 and GCK 2 and switch signals RSW, GSW, and BSW such as described above are generated on the basis of the timing setting data stored in the non-volatile memory 206 and the clock signal oscillated by the oscillation circuit 207. More specifically, timing is controlled by the pulse of the clock signal oscillated by the oscillation circuit 207 being counted by a counter, and the respective timing signal levels shifting every time this count value matches the values stored in the non-volatile memory 206, for example.

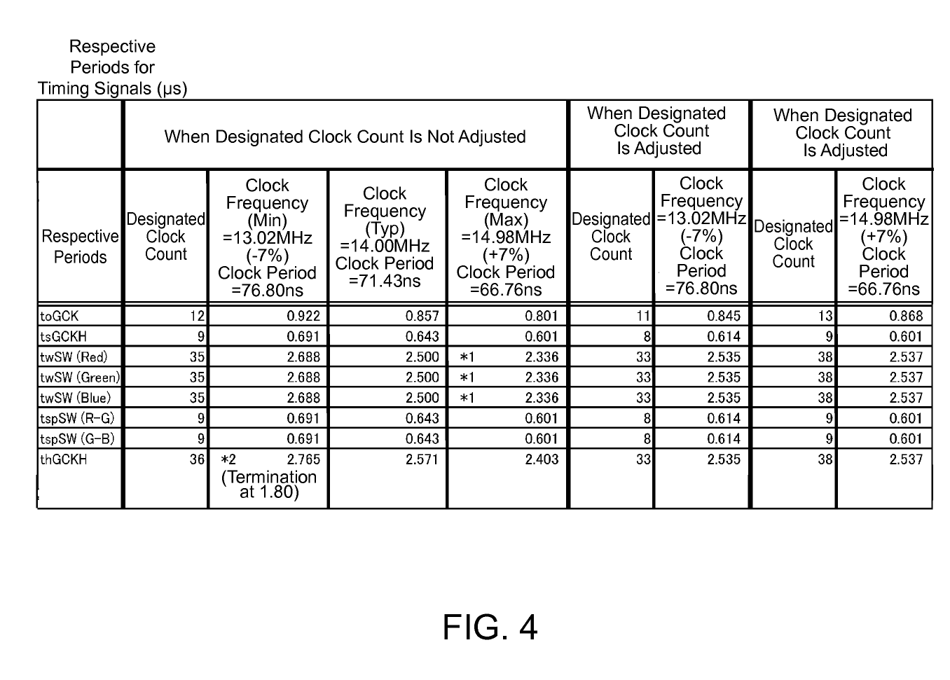

That is to say, the designated clock count for the respective periods is set in the non-volatile memory 206 as shown in FIG. 4, for example. In FIG. 4,

toGCK is the period after the horizontal synchronizing signal Hsync has fallen until the gate clock signal GCK1 or GCK2 enters H level and the TFTs of the liquid crystal panel 102 turn ON,

tsGCKH is the period from when the TFTs turn ON to the switch signal RSW entering H level and the start of voltages applied to the red pixel electrodes,

twSW (Red) is the period when the switch signal RSW enters H level and source voltages are applied to the red pixel electrodes,

twSW (Green) is the period when the switch signal GSW enters H level and source voltages are applied to the green pixel electrodes,

twSW (Blue) is the period when the switch signal BSW enters H level and source voltages are applied to the blue pixel electrodes,

tspSW (R-G) is the period from the switch signal RSW entering L level to the switch signal GSW entering H level,

tspSW (G-B) is the period from the switch signal GSW entering L level to the switch signal BSW entering H level, and

thGCKH is the period from the switch signal BSW entering L level to the gate clock signal GCK 1 or GCK 2 entering L level and the TFTs turning OFF.

When the number of clock signals such as those shown in FIG. 4 is set with respect to the respective periods described above and when the frequency of the clock signal oscillated by the oscillation circuit 207 are 14 MHz and 13.02 MHz or 14.98 MHz (14 MHz±7%), the length of the respective periods are as shown in FIG. 4.

If twSW (Red, Green, Blue) is too short, for example, a sufficient charge will not be stored because the time to apply the source voltages to the respective pixel electrodes through the switching circuit 106 is short, and this will cause a decrease in brightness, a shift in color balance, or the like. Specifically, if twSW (Red, Green, Blue) requires a period of 2.500 μs or greater, for example, then as shown by *1 in the drawing the above-mentioned conditions will not be met when there is a +7% deviation in the clock signal frequency, and a suitable display is not attained.

If thGCKH is too short, for example, then a sufficient charge will not be stored due to the gate clock signal GCK 1 or GCK 2 entering L level and the TFTs turning OFF before the switch signal BSW entering L level and the switch circuit 106 turns OFF and the applying of the source voltage stops completely. As shown by *2 in the drawing, when there is a −7% deviation in the clock signal frequency, for example, then the result of the calculation is 2.765 μs, but the storage of the charge to the respective pixel electrodes is forcibly terminated at 1.80 μs due to the horizontal synchronizing signal Hsync of the next scan line being externally inputted. Therefore, a proper display cannot be attained if thGCKH needs to be 2.400 μs or greater, for example.

As a countermeasure, in the liquid crystal display device 101 of the present embodiment, suitable timing control is performed by the designated clock count for the respective periods such as those shown in FIG. 4 being pre-set in the non-volatile memory 206 with respect to the deviation in clock signal frequency described above such as 14 MHz±7%, for example.

In the example above, for simplicity of explanation, the conditions of the periods twSW and thGCKH were explained as being fixed, but without being limited thereto, as described later, the optimal conditions and the like for the respective periods in FIG. 4 may be applied in accordance with the degree of delay and the like of operation of the liquid crystal display device 101 as necessary, for example.

(Configuration of Designated Clock Count)

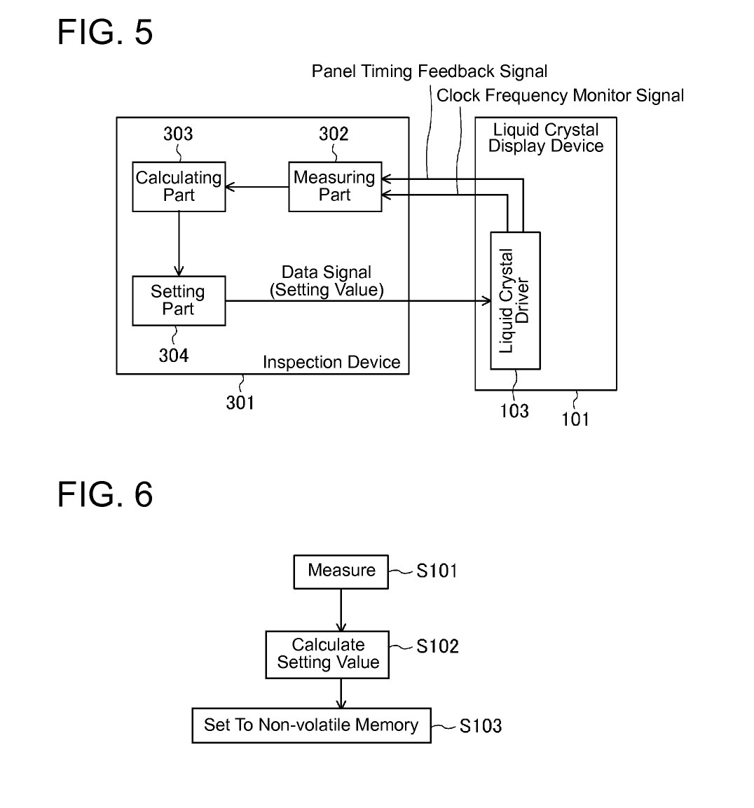

The designated clock count as described above is determined during manufacture of the liquid crystal display device 101, for example, by using an inspection device 301 (manufacturing device of a display device) as shown in FIG. 5 and a method of manufacturing as shown in FIG. 6 and stored in the non-volatile memory 206.

The inspection device 301 includes a measuring part 302 that measures the frequency of the clock signal oscillated in the liquid crystal driver 103 of the liquid crystal display device 101 and the delay time of the panel timing feedback signal outputted from the gate line driving circuit 104 of the liquid crystal display device 101, a calculating part 303 that calculates the designated clock count for the non-volatile memory 206 of the liquid crystal display device 103 on the basis of the measurement results, and a setting part 304 that writes the calculated clock count to the non-volatile memory 206 of the liquid crystal driver 103.

The above-mentioned inspection device 301 performs the steps below during manufacture of the liquid crystal display device 101, for example.

(S101) First, a standard clock count assuming a reference oscillation frequency of 14.00 MHz for the oscillation circuit 207 is set in the non-volatile memory 206 of the liquid crystal driver 103, and an actual or simulated display operation is performed. Thereafter, the actual oscillation frequency of the oscillation circuit 207 at that time and the delay time of the panel timing feedback signal outputted from the gate line driving circuit 104 of the liquid crystal display device 101 are measured.

(S102) The number of clock signals to be set in the non-volatile memory 206 of the liquid crystal driver 103 is calculated on the basis of the measurement results. Specifically, the conditions of the length of the respective periods shown in FIG. 4 and the like are found on the basis of the delay time of the panel timing feedback signal, and thereafter the designated clock count where such period lengths can be obtained by the actually measured clock signal frequencies of the oscillation circuit 207 is found.

(S103) The designated clock count found in the manner above is written to the non-volatile memory 206 of the liquid crystal driver 103 through the external interface circuit 201 and the register 205.

(Other Items)

Setting values being calculated by an oscillation frequency of the oscillation circuit 207 of the liquid crystal driver 103 and the panel timing feedback signal outputted from the gate line driving circuit 104 was shown above as an example, but without being limited thereto, the setting values may be calculated on the basis of various other types of values that act as indicators capable of being used for calculating the designated clock count. The relative amount of increase and decrease of setting values may be found or the like on the basis of setting values that are set to the non-volatile memory 206 during initial measurement without directly monitoring oscillation frequency of the oscillation circuit 207, for example. Without being limited to measuring the delay time of the panel timing feedback signal, the delay time of other circuits in which it is possible to have similar measurements of time delay may be measured or the like. Measurement may be performed or the like on the basis of change in the gate voltage of the gate line 105 that is nearest to the edge, for example.

An example was shown above in which the lengths of the respective periods of the gate clock signals GCK 1 and GCK 2, and the switch signals RSW, GSW, and BSW that control switching of the switch circuit 106 are controlled, but without being limited thereto, the respective timings may be controlled on the basis of pre-set setting values corresponding to similar deviation in oscillation frequency, deviation in circuit operation delay, and/or the like for various types of circuits in which a timing signal generated on the basis of setting values such as the pulse count of clock signals is used to control operation timing. Specifically, when a VRAM (video RAM) that stores image data is provided, for example, the reading of image data from the VRAM, transmission timing, and the like can be controlled in a similar manner. In a pixel division system liquid crystal display device, for example, applied voltage timing for the storage capacitor wiring line may be controlled or the like in a similar manner.

The control method as described above is not limited to a liquid crystal display device, and may be applied to a display device or the like using an organic EL (electro luminescence) display panel, for example.

### INDUSTRIAL APPLICABILITY

As described above, the present invention is useful for a display device that displays images on the basis of image signals, a method of manufacturing this display device, and a manufacturing device of this display device. In particular, the present invention is useful for a display device and the like in which display operation timing is controlled on the basis of clock signals oscillated inside the display device.

### DESCRIPTION OF REFERENCE CHARACTERS

101 liquid crystal display device

102 liquid crystal panel

103 liquid crystal driver

104 gate line driving circuit

105 gate line

106 switch circuit

107 source line

201 external interface circuit

202 line buffer

203 source line driving circuit

204 gamma correction circuit

205 register

206 non-volatile memory

207 oscillation circuit

208 selector

209 timing signal output circuit

210 panel interface circuit

211 driving voltage generator circuit

301 inspection device

302 measuring part

303 calculating part

304 setting part

1. A display device, comprising:
an oscillation circuit that oscillates a clock signal;
a non-volatile memory that stores values setting forth display operation timing of the display device in accordance with the clock signal; and
a timing signal output circuit that outputs timing signals controlling the display operation timing on the basis of the clock signal and the values stored in the non-volatile memory,
wherein the values stored in the non-volatile memory correspond to deviations in oscillation frequency of the oscillation circuit and deviations in delay of operation timing from respective targets.

2. The display device according to claim 1,
wherein display is performed in accordance with a charge that is stored between a pixel electrode and an opposite common electrode, and
wherein the timing signal controls a storage time of the charge between the pixel electrode and the opposite common electrode.

3. The display device according to claim 2,
wherein an image signal voltage is sequentially applied to respective pixel electrodes of red pixels of one display line, green pixels of one display line, or blue pixels of one display line, and
wherein the timing signal controls switching timing of the image signal voltage.

4. A method of manufacturing a display device that has: an oscillation circuit that oscillates a clock signal; a non-volatile memory that stores values setting forth display operation timing of the display device in accordance with the clock signal; and a timing signal output circuit that outputs timing signals controlling the display operation timing on the basis of the clock signal and the values stored in the non-volatile memory, the method comprising:
measuring actual operation timing of the display device reflecting deviations in oscillation frequency of the oscillation circuit and deviations in delay of display operation from respective targets;
calculating, on the basis of the measured operation timing, the values to be stored in the non-volatile memory at which the operation timing will be within a permissible range, and
storing the calculated values in the non-volatile memory.

5. The method of manufacturing a display device according to claim 4,
wherein the display device is configured such that display is performed in accordance with a charge that is stored between a pixel electrode and an opposite common electrode, and
wherein the timing signal controls a storage time of the charge between the pixel electrode and the opposite common electrode.

6. The method of manufacturing a display device according to claim 5,
wherein the display device is configured such that an image signal voltage is sequentially applied to respective pixel electrodes of red pixels of one display line, green pixels of one display line, or blue pixels of one display line, and
wherein the timing signal controls switching timing of the image signal voltage.

7. The method of manufacturing a display device according to claim 4,
wherein, in the step of measuring, operation delay time of a circuit that controls operation timing is measured by a frequency of the clock signal and the timing signal.

8. A manufacturing device of a display device that has: an oscillation circuit that oscillates a clock signal; a non-volatile memory that stores values setting forth display operation timing of the display device in accordance with the clock signal; and a timing signal output circuit that outputs timing signals controlling the display operation timing on the basis of the clock signal and the values stored in the non-volatile memory, the manufacturing device comprising:
a measuring part that measures actual operation timing of the display device reflecting deviations in oscillation frequency of the oscillation circuit and deviations in delay of display operation from respective targets;
a calculating part that calculates, on the basis of the measured operation timing, the values to be stored in the non-volatile memory at which the operation timing will be within a permissible range,
a setting part that stores the calculated values in the non-volatile memory.

9. The manufacturing device of the display device according to claim 8,
wherein the display device is configured such that display is performed in accordance with a charge that is stored between a pixel electrode and an opposite common electrode, and
wherein the timing signal controls a storage time of the charge between the pixel electrode and the opposite common electrode.

10. The manufacturing device of the display device according to claim 9,
wherein the display device is configured such that an image signal voltage is sequentially applied to respective pixel electrodes of red pixels of one display line, green pixels of one display line, or blue pixels of one display line, and
wherein the timing signal controls switching timing of the image signal voltage.

11. The manufacturing device of the display device according to claim 8,
wherein the measuring part operation delay time of a circuit that controls the operation timing is measured by a frequency of the clock signal and the timing signal.
